(19) United States
(12) Patent Application Publication
(10) Pub. No.: US 2014/0205485 A1
(43) Pub. Date: Jul. 24, 2014

(54) Soft Magnetic Powders and Compacts

(71) Applicant: Hitachi, Ltd., Tokyo (JP)

(72) Inventors: Kazuya NISHI, Hitachiota (JP); Yasuhisa AONO, Hitachi (JP)

(73) Assignee: Hitachi, Ltd., Tokyo (JP)

(21) Appl. No.: 14/220,672

(22) Filed: Mar. 20, 2014

Related U.S. Application Data
(62) Division of application No. 12/473,982, filed on May 28, 2009.

(30) Foreign Application Priority Data
May 30, 2008 (JP) 2008-141838

(51) Int. Cl. H01F 1/20; H01F 1/24; H01F 1/22

(52) U.S. Cl. CPC H01F 1/20; H01F 1/22; H01F 1/24
USPC 419/64; 419/62; 148/513

(57) ABSTRACT

A water atomized Fe powder for a magnetic compact reduced in deformation resistance during molding and annealing temperature for removing strains is provided. A compact having improved magnetic properties is also provided. The water atomized powder containing at least one element selected from Nb, Ta, Ti, Zr and V in an amount of 0.001-0.03 atom % is soft magnetic and has a precipitation in the matrix, which is composed of at least one element selected from Nb, Ta, Ti, Zr and V and oxygen as a main component and has an average size of 0.02-0.5 μm. Disclosed is a method for manufacturing a soft magnetic powder includes adding at least one element selected from Nb, Ta, Ti, Zr and V, and annealing in a hydrogen-containing reduction atmosphere. This method decrease gaseous impurities, particularly oxygen, and defuse it, to improve the magnetic properties of the powder and compact.

### CROSS REFERENCE TO RELATED APPLICATIONS

This application is a divisional of U.S. application Ser. No. 12/473,982, filed, May 28, 2009, which claims priority from JP 2008-141838, filed on May 30, 2008, the disclosures of which are expressly incorporated by reference herein.

### TECHNICAL FIELD

The present invention relates to a soft magnetic powder manufactured through a water atomization method and a magnetic compact using the same.

### BACKGROUND OF THE INVENTION

A magnetic compact is manufactured through compression molding of a soft magnetic powder under high pressure, and is used as magnetic cores of motors and reactors for power supply circuits. The powder magnetic core generally has isotropic magnetic properties and can be easily molded into a three-dimensional configuration. When the powder magnetic core is applied to e.g., electronic motors, it is expected to contribute to reducing size and weight thereof, different from a laminate magnetic core manufactured through laminating e.g., silicon steel plates. Particularly, the powder magnetic core using an Fe powder as a soft magnetic powder is inexpensive. In addition, since the Fe powder has high ductility, it has a high density and increased magnetic-flux density. Due to these advantages, the development of the powder magnetic core has been accelerated toward practical use, in recent years.

As a requisite property of a powder magnetic core, it is important to have a high magnetic-flux density. In addition, it is important to have a low energy loss (also called an iron loss) which generates when used under an alternating-current magnetic field. The iron loss is primarily expressed by the sum of an eddy current loss and a hysteresis loss. The eddy current loss is an energy loss caused by eddy current flowing through Fe powder particles forming the magnetic compact. As a means for reducing the eddy current loss, it is required to coat the surface of Fe powder particles as a magnetic material with a thin insulating film. On the other hand, the hysteresis loss (generated along with movement of the magnetic domain wall within the Fe powder) is strongly influenced by lattice strains caused within the Fe powder, more specifically, structural defects producing the lattice strains, such as voids or interstitial atoms (called point defects), lattice defects such as dislocation or grain boundary, and chemical defects such as impurity atoms except Fe or precipitations formed of the impurity atoms.

To reduce a hysteresis loss, an annealing must be applied to a compact of an Fe powder after compression molding to reduce strains introduced into the Fe powder by the molding process (i.e., lattice defects primarily including dislocations). As the temperature increases in the annealing, reduction of processing strains proceeds, which is therefore effective for reducing a hysteresis loss. However, when the annealing temperature is excessively increased beyond the heatproof temperature of the insulating film formed on the surface of the Fe powder particles, the insulating properties decrease, and an increasing eddy current loss problem arises. As described above, in development of improving the magnetic property of a magnetic compact, it is very difficult to decrease an eddy current loss and a hysteresis loss at the same time, at present.

When impurity elements and precipitations are contained in large amounts in an Fe powder, removal of the strains introduced by processing does not sufficiently proceed. The impurity elements (chemical defects) contained in the Fe powder are classified into gaseous impurities, which are represented by C (carbon), N (nitrogen) or O (oxygen), and metalline impurities, which are represented by Mn (manganese), Cr (chromium), Si (silicon), Cu (copper) or S (sulfur). In particular, the former gaseous impurities enter the interstitial position in crystal lattices, and push and broaden the crystal lattices inducing large strains. Alternatively, the gaseous impurities combine with metal atoms to generate compound precipitation phases, so-called precipitations, which increase deformation resistance (transfer resistance of dislocations that causes plastic deformation) during compression molding of a powder, impairs moldability. Furthermore, removal of processing strains by an annealing and primary crystallization are delayed. Accordingly, to reduce a hysteresis loss by facilitating improvement of moldability and removal of processing strains of a compact by an annealing, it is important to control a material composition for reducing gaseous impurities in the Fe powder as much as possible.

JP-A-2007-27320 mainly describes an Fe powder produced through a gas atomization method in which a high-pressure gas, such as argon or nitrogen, is sprayed to molten iron. In order to prevent influence of impurities C and S in an Fe powder, it is proposed to add a third element such as V, Nb, Ta, Ti or Zr to the Fe powder to aggregate C and S in the form of carbides and sulfates to reduce iron loss of a powder magnetic core. JP-A-2007-27320 discloses an example in which the coercive force of a powder magnetic core is reduced by adding Ti in an amount of 120 to 129 at. ppm and Zr in an amount of 110 at. ppm to an Fe powder. Inventors of JP-A-2007-27320 state that coercive force is effectively reduced when average sizes of carbides and sulfates generated through aggregation of impurities C and S are not less than 0.1 μm but not more than 10 μm.

### SUMMARY OF THE INVENTION

On the other hand, as a pure Fe powder for industrial use, an inexpensive water atomized powder is widely used. The water atomized Fe powder is produced in a process where high pressure water is sprayed to molten iron melted at high temperature to cool and atomize. Compared to the gas atomization method, the water atomization method is extremely inexpensive and thus excellent for large scale production of the power.

Furthermore, a water atomized powder significantly differs from a gas atomized powder in composition and material structure. Regarding the structure, the water atomized powder has an oxide film on the surface thereof, which is formed by the reaction between molten iron and water. Regarding the composition, the water atomized powder contains a large amount of oxygen. Accordingly, the strategies on how to control the material to improve magnetic properties differ between the two methods. It is the most important to control the effect of a large amount of oxygen contained in the Fe powder in the water atomization. However, JP-A-2007-27320 discussed the counterpart on C and S, but the control of the effect of oxygen is not considered.

Furthermore, JP-A-2007-27320 discloses that precipitations such as carbides and sulfides having an average particle size of 0.1 μm to 10 μm have been already produced in molten iron and remained therein, and therefore, the matrix has been free from the effect of C and S themselves in the gas atomized powder. On the other hand, the water atomized powder containing a large amount of oxygen differs from the gas atomized powder in situation. Industrially, it is subjected to a reduction heat treatment to reduce the content of oxygen, in the temperature range of 850° C. to 1000° C. However, it is quite difficult to grow precipitations sufficiently to the extent that preferable properties for a pressed powder are obtained. There is a problem that an undesirable effect of oxygen is difficult to be reduced.

Thus, an object of the present invention is to provide a magnetic powder reduced in undesirable effect of oxygen upon compactibility and heat removal of strains from a compact (or magnetic properties of the compact).

Characteristics of the present invention for overcoming the above problem resides in that a soft magnetic powder containing iron as a main component, in which a predetermined additive is added and a compound of the additive and oxygen is grown to a predetermined size. More specifically, the soft magnetic powder is made of iron containing at least one element selected from the group consisting of V, Nb, Ta, Ti and Zr in an amount of 0.001 to 0.03 atom %, an unavoidable metal impurity in an amount of not more than 0.25 mass %, and carbon, nitrogen and oxygen in an amount of not more than 0.05 mass % and includes precipitation particles having an average particle size of not less than 0.02 μm but not more than 0.5 μm, which particles contains, as a main component, at least one element selected from the group consisting of V, Nb, Ta, Ti and Zr and oxygen within the matrix. Furthermore, since the soft magnetic powder of the present invention is produced through a water atomization method in which a molten alloy is cooled by spraying water, it has an oxide layer formed on the surface.

Other characteristics of the present invention resides in a method of manufacturing a magnetic compact using the soft magnetic powder, which includes atomizing iron through a water atomization method and annealing it in the temperature range of 800° C. to 1000° C. in a reduction atmosphere containing hydrogen. More specifically, it resides in that at least one element selected from the group consisting of V, Nb, Ta, Ti and Zr is added to iron in an amount of 0.001 to 0.03 atom % and a compact formed by compaction is annealed at a recrystallization temperature of not higher than 600° C.

V, Ti, Al, Si and Zr and the like are elements forming thermodynamically stable oxides. When these elements are contained not in a small amount but in a large amount beyond the range of the present invention, they react preferentially with oxygen, which entering from the surface through decomposition of water, at the region near the surface of the powder particles, accelerate oxygen absorption and produce an excessive amount of stable oxides during rapid-cooling. The excessive amount of oxides impairs compactibility and inhibits removal of strains by an annealing (primary crystallization at a lower temperature) in a molding process, possibly increasing an iron loss.

Compound particles of additives are generated by aggregation from the matrix during annealing. However, if the particles are grown excessively, they have a large effect upon strains. When aggregation is insufficient, strains are generated around oxygen atoms and the like as stated above.

The water atomized Fe powder contains a large amount of oxygen produced by a reaction with water during atomization, as stated above. According to the above constitution, undesirable effects of oxygen upon compactibility and heat removal of strains from the compact (or magnetic properties of the compact) are reduced. The approach for reducing oxygen resolves the problem to reduce C and N, at the same time. However, the contents of these elements are low in the water atomized iron powder compared to that of oxygen.

According to the above constitution, a powder for a magnetic compact reduced in the oxygen effect can be provided at low cost. More specifically, the deformation resistance of a water atomized Fe powder and the primary crystalline temperature thereof can be reduced. Furthermore, when a magnetic compact formed of the water atomized Fe powder particles coated with an insulation film is annealed, an iron loss is reduced.

### BRIEF DESCRIPTION OF THE DRAWINGS

FIG. 1 shows the steps of manufacturing water atomized Fe powder and thermally treating the powder in a hydrogen atmosphere;

FIG. 2 is an isochronal annealing curve of the Vickers hardness (load: 10 g) of developed material No. 5;

FIG. 3 is a schematic view of the structure of a compacted powder particle of a compact of developed material No. 5 observed by a transmission electron microscope;

FIG. 4 is a photograph of a precipitation in the matrix of a powder particle of the compact of the developed material No. 5 observed by a transmission electron microscope; and

FIG. 5 is a three-dimensional schematic view of a compacted magnetic core produced through molding and serving as a magnetic core of motor stators.

The other objects, characteristics and advantages will be apparent from the following description of embodiments of the present invention referring to the accompany drawings.

### DETAILED DESCRIPTION OF THE INVENTION

The present inventors conducted studies on a method of reducing oxygen as gaseous impurities and undesirable actions of C and N for improving properties of a water atomized Fe powder such as lowering an iron loss, which is achieved though lowering deformation resistance and lowering primary crystallization temperature, and through annealing an insulation-coated magnetic compact of a water atomized Fe powder.

The water atomized Fe powder contains a large amount of oxygen, which is generated by a reaction with water during an atomization process but the contents of C and S are not large, different from a gas atomized powder. Oxygen atoms impair compactibility and inhibit removal of strains (primary crystallization at a lower temperature) by an annealing during a molding process. Therefore, there is a high possibility of increasing an iron loss.

Accordingly, to reduce the actions of gaseous impurities O, C and N, is thought of a method of controlling the structure of a material for purifying the matrix of the water atomized Fe powder and of producing such a material. Elements having high affinity for the gaseous impurities O, C and N are added within appropriate content ranges, and the impurities remaining in the powder are removed from the matrix as the precipitations with the added elements.

In the present invention, to reduce the actions of gaseous impurities O, C and N, an annealing in a hydrogen atmosphere is sufficiently applied to a water-atomized powder to reduce the amount of gaseous impurities contained in the powder. Further, elements having high affinity to the above gaseous impurities are added within an appropriate content range and allowed to aggregate with the remaining gaseous impurities as oxides, carbides, nitrides and mixed compounds thereof. Furthermore, the gaseous impurities are removed from the matrix in the form of precipitations with the addition elements, thereby purifying the matrix of the water atomized Fe powder.

More specifically, at least one element selected from the group consisting of Nb, Ta, Ti, Zr and V is added as the addition element. The total addition amount must be set appropriately within the range in which the deformation resistance and primary recrystallization temperature of the powder and the iron loss of its compact can be reduced.

Furthermore, it is possible to reduce the amount of gaseous impurities contained in the powder by sufficiently applying the hydrogen annealing. When a powder is atomized through a water atomization method and then subjected to an annealing in a reduction atmosphere containing hydrogen gas within the temperature range of 800° C. to 1000° C., a gaseous impurity concentration can be reduced. The remaining gaseous impurities are aggregated as precipitations with the addition elements into large particles to purify the matrix of the powder. It is particularly preferred that the annealing is performed in the range of 850 to 1000° C.

As a result, novel and inexpensive soft magnetic Fe powder, a technique for controlling the structure of the material and a method of producing the material can be provided.

The atomized Fe powder for forming a compact to be used in the present invention contains at least one additional element selected from the group consisting of Nb, Ta, Ti, Zr and V. These elements has properties that they strongly react with gaseous impurities O, C and N in the matrix of the Fe powder to produce aggregates such as oxides, carbides, nitrides and mixed compounds thereof containing other components, and serve to purify the matrix.

Among these precipitations, carbides and nitrides are obtained by a reaction with an atomic ratio of 1:1, and have much lower standard free energy of formation than those of carbides and nitrides of unavoidable impurities Cr, Mn and Si in Fe, and thus are thermodynamically stable. The additional elements Nb, Ta, Ti, Zr and V have an effect of trapping solid solute C and N whether single additional element is added or a plurality elements are simultaneously added. In the water atomized Fe powder of the present invention, since C and N in the molten particles react with water during the water atomization process, the contents of C and N in the resultant atomized powder obtained by rapid solidification are reduced. Conversely, the content of oxygen increases. In this respect, the water atomization process differs from the gas atomization process using He, Ar or the like as a cooling medium, in the composition after the process. When the content of oxygen increases, the amount of oxide precipitations increases compared to carbides and nitride precipitations in an annealing process of the powder.

Here, a method of manufacturing the Fe powder containing impurity elements and stabilization elements for fixing the impurity elements will be described. The Fe powder of the present invention is produced through a water atomization method. Raw-material of iron is selected such that unavoidable impurities including Cr, Mn and Si satisfy the following ranges shown below, placed in a container such as a crucible, and heated to high temperature to obtain a molten state. At the same time, at least one element selected from the group consisting of Nb, Ta, Ti, Zr and V is added, stirred and homogenized. The molten iron satisfying a predetermined chemical composition at this stage is rapidly solidified by spaying high-pressure water thereto and atomized. The atomized powder particles are collected.

The Fe powder for forming a compact used in the present invention contains a large amount of oxygen (about 0.2 mass % or more) immediately after the water atomization process, as mentioned above. The surface layer is coated with an oxide layer and a large amount of oxygen is rapidly cooled and solid soluted also within the matrix. To reduce the content of oxygen in the water atomized powder, it is effective to employ adding Nb, Ta, Ti, Zr or V in combination with a process of annealing in a hydrogen-containing reducing gas. A significant effect is obtained within the temperature range of not lower than 800° C. but not higher than 1000° C. The case where the temperature is not lower than 1000° C. is not preferred since aggregation and sintering of a powder excessively proceed. In contrast, the case where the temperature range of not higher than 800° C. is not preferred since the effect of reducing the oxygen content by the hydrogen treatment is suppressed. Furthermore, the hydrogen treatment can be stably performed at a temperature of not lower than 850° C.

The amount of additional element (Nb, Ta, Ti, Zr or V) varies depending upon the content of gaseous impurities (O, C, N) as well as the content of unavoidable impurities strongly bindable to oxygen in particular. Among the unavoidable impurities, particularly Si, Mn and Cr dominantly included as impurities have a large effect. It is desirable that the total amount of Si, Mn and Cr is not more than 0.15% by mass and the total amount of O, C and N is not more than 0.05% (about 0.18% by atom). In this case, it is preferred that the amount of at least one additional element selected from the group consisting of Nb, Ta, Ti, Zr and V falls within the range of 0.001 to 0.03% by atom, and particularly, 0.003 to 0.03% by atom. Note that when Nb, Ta, Ti, Zr or V is added singly, the above addition amount of 0.03% by atom corresponds to, respectively, about 0.05%, 0.097%, 0.025%, 0.05% or 0.027%. When the additional elements are added within these content range, O, C and N, which increase deformation resistance and recrystallization temperature of a powder and an iron loss of a compact, are aggregated as precipitations. Furthermore, the aforementioned hydrogen annealing is applied in combination so as to grow coarse precipitations during the annealing. Thus, an object of rendering O, C and N to be more harmless can be attained. In this step, formation of oxides, particularly mixed oxides, plays an important role. When the additional elements are contained in an amount of not less than 0.03% by atom, growth of the precipitations does not proceed. As a result, fine precipitations remain and distribute. Adversely, the presence of fine precipitations densely distributed greatly inhibits a desired improvement of properties.

As the content of unavoidable impurities in the hydrogen-annealed powder to obtain preferable properties of an Fe powder for forming a compact in view of economy and productivity, it is required that the amount of elements of atomic number of not less than 9 is not more than 0.25% by mass and the amount of elements of atomic number of not more than 8 is not more than 0.05% by mass. The elements of atomic number of not less than 9 are mostly metal elements. Particularly, Cr, Mn and Si tend to be contained largely due to manufacturing reasons and they should be limited.

Cr is expected to aggregate with O, C and N. The content of Cr is specified to be not more than 0.05% by mass. When the content exceeds 0.05% by mass, Cr reacts with oxygen diffused from the surface into the interior of an Fe powder particle during a manufacturing process to form a large number of stable Cr oxides. Accordingly, these oxides are not preferable since they delay heat removal of strains from a compact and increase a hysteresis loss. Particularly, the content of Cr is more desirably not more than 0.03% by mass.

Mn is present in a large amount due to manufacturing reasons. The content of Mn is specified to be not more than 0.1% by mass. When the content exceeds 0.1% by mass, Mn reacts with oxygen diffused from the surface into the interior of an Fe powder particle in a manufacturing process to form a large number of stable Mn oxides, similarly to the case of Cr. It is not preferable since the Mn oxides delay heat removal of strains from a compact and increase a hysteresis loss.

Since Si has a low free energy of formation of an oxide, Si more easily forms an oxide. In addition, since the formed oxide is stable, it hardly grows. Accordingly, it is preferred that the content of Si is lowered as low as possible and set to be not more than 0.02% by mass. When the content exceeds 0.02% by mass, Si reacts with oxygen diffused from the surface into the interior of an Fe powder particle during a manufacturing process to form a large number of stable Si oxides. Si oxides delay heat removal of strains from a compact and increase a hysteresis loss.

Among the unavoidable impurity elements of atomic number being not more than 8, C, O and N are dominant. In the water atomized powder, the total amount of C and N is specified to be not more than 0.002% by mass. The amount of C and N can be lowed for the reasons mentioned above and can be further reduced through the hydrogen annealing. In the gaseous impurities, O is dominant. The oxygen content in the water atomized powder subjected to hydrogen annealing including the surface oxide layer, is at most about 0.05% (about 0.18% by atom). The total amount of C, O and N is preferably not more than 0.05% by mass.

Nb effectively works for removing O, C and N. O, C and N are fixed in an Fe powder by rapid cooling during a water atomization process and removed by the hydrogen annealing in the range of 800° C. to 1000° C. as mentioned above. The remaining O, C and N precipitate as oxides containing Nb, NbC or NbN during the annealing. These precipitations grow with the passage of processing time and purify the powder matrix. The oxides may be mixed oxides formed with other metal elements contained in Fe. The purification increases the effects of reducing deformation resistance and primary recrystallization temperature of an Fe powder and an iron loss of a compact. When the addition amount of Nb exceeds 0.03% by atom, the density of particularly oxides increases, and the effect of purifying the matrix through the growth of precipitations is impaired. Therefore, the Nb content is preferably not more than 0.03%. However, if the content is less than 0.001%, the effect further decreases. Hence, the content preferably falls within the range of 0.001 to 0.03%. When at least one element selected from Ta, Ti, Zr and V is added simultaneously with Nb, the total amount including Nb preferably falls within the range of 0.001 to 0.03%. The elements are particularly preferably to be added in an amount of not less than 0.003%, while it varies depending upon the amount of remaining oxygen and the like.

Ta effectively works for removing O, C and N. O, C and N are fixed in an Fe powder by rapid cooling during a water atomization process and removed by the hydrogen annealing in the range of 800° C. to 1000° C. as mentioned above. The remaining O, C and N precipitate as oxides containing Nb, TaC or TaN during the annealing. These precipitations grow with the passage of processing time and purify the powder matrix. The oxides may be mixed oxides formed with other metal elements contained in Fe. The purification increases the effects of reducing deformation resistance and primary recrystallization temperature of an Fe powder and an iron loss of a compact. When the addition amount of Ta exceeds 0.03% by atom, the density of particularly oxides increases, and the effect of purifying the matrix through the growth of precipitations is impaired. Therefore, the Ta content is preferably not more than 0.03%. However, if content is less than 0.001%, the effect further decreases. Hence, the content preferably falls within the range of 0.001 to 0.03%. When at least one element selected from Nb, Ti, Zr and V is added simultaneously with Ta, the total amount including Ta preferably falls within the range of 0.001 t 0.03%.

Ti works more effectively than Nb, Ta or V, for removing O, C and N. O, C and N are fixed in an Fe powder by rapid cooling during a water atomization process and removed by the hydrogen annealing in the range of 800° C. to 1000° C. as mentioned above. The remaining O, C and N precipitate as oxides containing Ti, TiC or TiN during the annealing. These precipitations grow with the passage of processing time and purify the powder matrix. The oxides may be mixed oxides formed with other metal elements contained in Fe. The purification increase the effects of reducing deformation resistance and primary recrystallization temperature of an Fe powder and an iron loss of a compact. Ti binds to O, C and N more strongly than Nb, Ta or V. When the addition amount of Ti exceeds 0.03% by atom, the density of precipitations with them increases and present more stably, and the effect of purifying the matrix through the growth of precipitations is impaired. Therefore, the Ti content is preferably limited to not more than 0.03%. Furthermore, sufficient effect can be expected in the content of 0.001%. Hence, the content more preferably falls within the range of 0.001 to 0.03%. When at least one element selected from Nb, Ta, Zr and V is added simultaneously Ti, the total amount including Ti preferably falls within the range of 0.001 to 0.03% and particularly 0.003 to 0.03%.

Zr works, similarly to Ti, more effective than Nb, Ta or V in removing O, C and N. O, C and N are fixed in an Fe powder by rapid cooling during a water atomization process and removed by the hydrogen annealing in the range of 800° C. to 1000° C. as mentioned above. The remaining O, C and N precipitate as oxides containing Zr, ZrC or ZrN during the annealing. These precipitations grow with the passage of processing time and purify the powder matrix. The oxides may be mixed oxides formed with other metal elements contained in Fe. The purification increases the effects of reducing deformation resistance and primary recrystallization temperature of an Fe powder and an iron loss of a compact. Zr binds to O, C and N more strongly than Nb, Ta or V. When the addition amount of Zr exceeds 0.03% by atom, particularly the density of precipitations with them increases and present more stably, and the effect of purifying the matrix through the growth of precipitations is impaired. Therefore, the Ti content is preferably limited to not more than 0.03%. Furthermore, sufficient effect can be expected in the content of 0.001%. Hence, the content is more preferably fall within the range of 0.001 to 0.03%. When at least one element selected from Nb, Ta, Ti and V is added simultaneously with Zr, the total amount including Zr preferably falls within the range of 0.001 t 0.03% and particularly 0.003 to 0.03%.

V effectively works in removing O, C and N. O, C and N are fixed in an Fe powder by rapid cooling during a water atomization process and removed by the hydrogen annealing in the range of 800° C. to 1000° C. as mentioned above. The remaining O, C and N precipitate as oxides containing Nb, VC or VN during the annealing. These precipitations grow with the passage of processing time and purify the powder matrix. The oxides may be mixed oxides formed with other metal elements contained in Fe. The purification increases the effects of reducing deformation resistance and primary recrystallization temperature of an Fe powder and an iron loss of a compact. When the addition amount of V exceeds 0.03% by atom, the density of particularly oxides increases, and the effect of purifying the matrix through the growth of precipitations is impaired. Therefore, the V content is preferably not more than 0.03%. However, when the content is less than 0.001%, the effect further decreases. Hence, the content preferably falls within the range of 0.001 to 0.03%. When at least one element selected from Nb, Ta, Ti and Zr is added simultaneously with V, the total amount including V preferably falls within the range of 0.001 to 0.03% and particularly 0.003 to 0.03%.

Since the gaseous impurities have been lowered in the hydrogen annealing, the amount of precipitations in the matrix of the water atomized Fe powder subjected to hydrogen annealing according to the present invention is low. From this, an average particle size of the precipitations is preferably not larger than 0.5 μm.

The dimensions of precipitations are restricted as follows. The Fe powder produced through the water atomization method has a structure that is the molten Fe is broken and rapidly solidified. While the surface of the particles is coated with an oxide film through a reaction with water (i.e., oxygen), component atoms are frozen in a solid-solution state in the interior of the particle. The structure completely differs from that of a solidified one obtained by melting in a crucible and cooling in the air. The latter structure is in the state of thermal equilibrium, in which an oxide inclusion, MnS and the like in the order of μm are present. However, in the frozen structure of the water atomized powder, they are hardly generated. While gaseous impurities are decreased by reduction during the annealing in a hydrogen atmosphere at 800° C. to 1000° C. as described above, frozen component atoms proceed to diffuse at the same time to form precipitations. Gaseous impurities that have been decreased in concentration but still remains, dominating oxygen in particular, reacts with metal component atoms to precipitate and grow. In consideration of such a phenomenon, the precipitations of dominating oxides generated in the hydrogen annealing at 800° C. to 1000° C. for one hour is present in low density and preferably have an average particle size not larger than 0.5 μm but not smaller than 0.02 to 0.03 μm.

Since the hydrogen-annealed water atomized Fe powder according to the present invention is subjected to hydrogen annealing and added with Nb, Ta, Ti, Zr or V for reducing gaseous impurities O, C, and N which inhibit (or resist) plastic deformation during compression molding of the powder, the average micro-Vickers hardness of the powder decreases to not greater than 120. From this, molding pressure required for forming a compact having the same density as a conventional one is made lower than that of the conventional one.

If the water atomized Fe powder of the present invention is not subjected to the hydrogen annealing, a large amount of gaseous impurity atoms (O, C, N) is compulsively fixed and dissolved in the Fe matrix in a solid solution state while keeping a thermally non-equilibrium state by rapid cooling during the water atomization process. Particularly, since oxygen is contained in a large amount, it partly remains as oxides of mainly iron in the proximity of the surface of the Fe powder. Furthermore, gaseous impurities C and N except oxygen remain in the Fe powder in a total amount of C and N of at most about 0.01%. These impurities act as follows. Due to the lattice strains of the impurities, deformation resistance (transfer resistance of dislocations that causes plastic deformation) increases during compression molding of the powder, and, on the other hand, an iron loss and magnetic properties such as magnetic density deteriorate. As other effects, moldability of the powder is impaired and the density of a compact possibly decreases. Furthermore, when the problems that removal of processing strains by a strain-removal annealing delays and primary recrystallization delays, the magnetic properties of a compact significantly degrade.

The hydrogen annealing is important to reduce deformation resistance during compression molding of the Fe powder and to improve magnetic properties of the compact. The hydrogen annealing can decrease the concentration of the gaseous impurities by reduction. Furthermore, the remaining gaseous impurities in a non-equilibrium solid solution state are allowed to aggregate and grow as precipitate with additional elements (Nb, Ta, Ti, Zr or V), so that the matrix of the powder is purified.

The hydrogen annealing is performed under an atmosphere principally containing hydrogen gas, such as a pure hydrogen atmosphere, a mixed atmosphere of hydrogen and nitrogen which is obtained by decomposition of ammonia or the like, a mixed atmosphere of pure hydrogen and ammonia decomposition gas. The hydrogen annealing is performed by placing an iron powder in a static environment, such as placing it directly in a heating apparatus, and supplying a reduction atmosphere or introducing hydrogen in the heating apparatus. Alternatively, heating of the powder in a dynamic environment is also an effective method for reducing the gaseous impurities, such as placing the iron powder on a moving belt and moving the belt within a furnace to bring the powder into contact with the reduction atmosphere, or rotating a cylindrical heating furnace.

The hydrogen-annealed water atomized Fe powder according to the present invention is subjected to molding in which plastic deformation is excessively applied to the powder under high pressure to obtain a compact. To improve the magnetic properties of the compact, it is necessary to perform an annealing in order to remove strains (which are generated due to e.g., lattice defects) within the compact. Furthermore, to use a compact as a magnetic core, the surface of the powder must be coated with a thin insulating film. Therefore, in order to maintain insulating properties of the film, the above annealing cannot be performed at a temperature exceeding the heatproof temperature of the film.

The insulating film presently used in the art is an iron phosphate glass (Fe—P—O). The heatproof temperature of the iron phosphate glass is said to be at most around 550° C. Therefore, the primary recrystallization temperature of the water atomized Fe powder subjected to hydrogen annealing according to the present invention is preferred to be not higher than 600° C.

Since the water atomized Fe powder is subjected to hydrogen annealing for removing strains and reducing gaseous impurities O, C, N which inhibits the primary recrystallization, and Nb, Ta, Ti, Zr or V is added, the aforementioned range can be employed.

The surface of the water atomized powder subjected to hydrogen annealing according to the present invention is coated with an insulating film, made composite powder, and then subjected to compression molding to obtain a magnetic compact, which can be used as a magnetic core of e.g., motors and electric circuits. Furthermore, the magnetic compact obtained by compression molding is preferably annealed for removing strains in a temperature range sufficient to maintain the heatproof of the insulting film, specifically at not higher than 550° C. Owing to the strain-removing annealing, properties such as high magnetic-flux density and a low iron loss can be obtained. Due to a low deformation resistance of the annealed powder, a compact can have a density of not less than 7.45. The particle size of the Fe powder of the present invention is preferably 100 to 400 μm in average. For example, the Fe powder preferably has a particle size distribution between 100 to 300 μm and an average particle size of 200 μm. When an average particle size is small and extremely small particles are dominated, the surface area of the particles increases and the contact interface between the particles increases, so that an iron loss of the magnetic compact increases. On the other hand, when an average particles size is large and extremely large particles are dominated, eddy current loss is undesirably generated.

The Fe powder, soft magnetic material, powder magnetic core and the methods for manufacturing the same according to the present invention are preferably used in motor cores, electromagnetic valves, reactors or general electromagnetic components.

### EXAMPLES

The present invention will be more specifically described by way of Examples below.

### Example 1

In this example, several kinds of water atomized powders were produced by adding Nb, Ta, Ti, Zr or V to pure Fe and properties of the powders were investigated.

FIG. 1 shows the steps of manufacturing a water atomized Fe powder. Pure Fe was selected and additional elements were blended so as to obtain a predetermined chemical composition. These materials were melted and molten Fe was atomized by high pressure water and rapidly solidified to obtain atomized Fe powder (Steps 1 and 2). The particles of the Fe powder, which had an oxide film on the surface, were sieved to obtain Fe powder having an average particle size of 100 μm. The Fe powder thus sieved was subjected to an annealing in an atmosphere where dry hydrogen flows at 950° C.±4° C. for one hour in order to reduce gaseous impurities (Steps 3 and 4). Since a part of the powder aggregate during the annealing, it was mechanically pulverized to separate individual particles, but so as not to introduce strains as carefully as possible (Step 5). If there is a possibility that strains are introduced, annealing may be performed, after pulverization, in a reduction atmosphere containing hydrogen or in vacuum at 600° C. for 30 minutes to one hour (step 6). In this example, Step 6 was conducted for 30 minutes in vacuum. Black powder surface immediately after water atomization was changed to light gray surface by the hydrogen annealing.

Table 1 shows the results of chemical analysis for the compositions of the manufactured water atomized Fe powders.

TABLE 1
$\frac{mass \%}{( atom \% )}$

| Water atomized | | | | | | | | | | | |
|---|---|---|---|---|---|---|---|---|---|---|---|
| powder | Cr | Mn | Si | Nb | Ta | Ti | Zr | V | S | C | N |
| Comparative | 0.021 | 0.055 | 0.005 | <0.001 | <0.001 | <0.001 | <0.001 | <0.001 | 0.005 | 0.002 | 0.001 |
| material No. 1 | | | | | | | | | | | |
| Comparative | 0.020 | 0.049 | 0.004 | <0.001 | <0.001 | <0.001 | <0.001 | <0.001 | 0.005 | 0.002 | 0.001 |
| material No. 2 | | | | | | | | | | | |
| Comparative | <0.001 | <0.001 | <0.001 | <0.001 | <0.001 | <0.001 | <0.001 | <0.001 | 0.003 | 0.003 | 0.002 |
| material No. 3 | | | | | | | | | | | |
| Developed | 0.018 | 0.058 | 0.004 | 0.0456 | | | | | 0.006 | 0.003 | 0.002 |
| material No. 4 | | | | (0.0274) | | | | | | | |
| Developed | 0.022 | 0.061 | 0.003 | 0.0213 | | | | | 0.006 | 0.003 | 0.001 |
| material No. 5 | | | | (0.0126) | | | | | | | |
| Developed | 0.025 | 0.055 | 0.005 | 0.0070 | | | | | 0.007 | 0.002 | 0.002 |
| material No. 6 | | | | (0.0042) | | | | | | | |
| Developed | 0.020 | 0.067 | 0.004 | | 0.0910 | | | | 0.006 | 0.002 | 0.001 |
| material No. 8 | | | | | (0.0281) | | | | | | |
| Developed | 0.023 | 0.058 | 0.007 | | 0.0453 | | | | 0.006 | 0.002 | 0.001 |
| material No. 9 | | | | | (0.0140) | | | | | | |
| Developed | 0.016 | 0.056 | 0.006 | | 0.0123 | | | | 0.006 | 0.002 | 0.001 |
| material No. 10 | | | | | (0.0038) | | | | | | |
| Developed | 0.020 | 0.046 | 0.004 | | | 0.0237 | | | 0.005 | 0.002 | 0.002 |
| material No. 11 | | | | | | (0.0277) | | | | | |
| Developed | 0.018 | 0.048 | 0.008 | | | 0.0133 | | | 0.006 | 0.001 | 0.002 |
| material No. 12 | | | | | | 0.0155 | | | | | |
| Developed | 0.016 | 0.057 | 0.006 | | | 0.00283 | | | 0.006 | 0.002 | 0.001 |
| material No. 13 | | | | | | (0.0033) | | | | | |
| Developed | 0.023 | 0.053 | 0.003 | | | | 0.0476 | | 0.005 | 0.001 | 0.002 |
| material No. 14 | | | | | | | (0.0290) | | | | |
| Developed | 0.025 | 0.042 | 0.004 | | | | 0.0204 | | 0.005 | 0.002 | 0.001 |
| material No. 15 | | | | | | | (0.0125) | | | | |
| Developed | 0.014 | 0.059 | 0.006 | | | | 0.0057 | | 0.004 | 0.002 | 0.001 |
| material No. 16 | | | | | | | (0.0035) | | | | |
| Developed | 0.021 | 0.062 | 0.007 | | | | | 0.0245 | 0.005 | 0.002 | 0.002 |
| material No. 17 | | | | | | | | (0.0269) | | | |
| Developed | 0.024 | 0.072 | 0.003 | | | | | 0.0095 | 0.004 | 0.003 | 0.001 |
| material No. 18 | | | | | | | | (0.0104) | | | |
| Developed | 0.018 | 0.053 | 0.005 | | | | | 0.0073 | 0.005 | 0.002 | 0.002 |
| material No. 19 | | | | | | | | (0.0044) | | | |
| Developed | 0.021 | 0.054 | 0.006 | 0.0128 | | | | 0.0082 | 0.007 | 0.002 | 0.001 |
| material No. 20 | | | | (0.0077) | | | | (0.0090) | | | |
| Developed | 0.027 | 0.055 | 0.005 | 0.0188 | | 0.00521 | | | 0.007 | 0.002 | 0.002 |
| material No. 21 | | | | (0.0113) | | (0.0062) | | | | | |
| Developed | 0.025 | 0.053 | 0.005 | 0.0145 | | | 0.0271 | | 0.006 | 0.002 | 0.002 |
| material No. 22 | | | | (0.0087) | | | (0.0166) | | | | |
| Developed | 0.024 | 0.057 | 0.006 | | 0.278 | | | 0.0047 | 0.006 | 0.003 | 0.002 |
| material No. 23 | | | | | (0.086) | | | (0.0051) | | | |
| Developed | 0.025 | 0.049 | 0.004 | | | 0.0128 | | 0.0056 | 0.006 | 0.002 | 0.001 |
| material No. 24 | | | | | | (0.0149) | | (0.0061) | | | |
| Developed | 0.028 | 0.055 | 0.005 | 0.0116 | | 0.00531 | | 0.0049 | 0.005 | 0.003 | 0.002 |
| material No. 25 | | | | (0.0070) | | (0.0062) | | (0.0054) | | | |

Each powder was produced by blending individual components in accordance with a predetermined chemical composition, melting and atomizing through the water atomization method. Twenty five Fe powders are water atomized Fe powders, and contain a large amount of oxygen as an impurity (in the range of 0.17 to 0.2% by mass), which largely contributes to formation of an oxide film. The concentration of impurity C is about 0.001 to 0.003%. The concentration of N is not more than 0.002% in any powder, which is very low. Considerable amounts of C and N appear to be removed during atomization through the reaction with water (i.e., oxygen).

In Table 1, samples of Nos. 1 to 3 are comparative materials, which do not contain Nb, Ta, Ti, Zr or V. Sample No. 3 is a water atomized powder using materials having four nines purity containing an extremely low amount of metal impurities. In materials of from No. 4 of the present invention, samples of Nos. 4 to 19 are powders to which Nb, Ta, Ti, Zr or V are added singly. Furthermore, samples of Nos. 20 to 25 are powders to which Nb, Ta, Ti, Zr and V are added in combination. In the powders except sample No. 3, impurities Cr, Mn and Si are added in an amount of not more than 0.03% by mass, not more than 0.1% by mass and not more than 0.02%, respectively.

Table 2 shows the properties (oxygen concentration, Vickers hardness, primary crystallization temperature) of water atomized powders subjected to hydrogen annealing, and the properties (coercive force, density and specific resistance) of compacts formed of powders having particles coated with an insulating film.

TABLE 2

| | | | | | Primary recrys- | | | |
|---|---|---|---|---|---|---|---|---|
| Water atomized | C concen- | N concen- | O concen- | Vickers | tallization | Coercive | | Specific |
| powder after | tration | tration | tration | hardness | temperature | force | Density | resistance |
| hydrogen annealing | (mass %) | (mass %) | (mass %) | (HV) | (° C.) | (A/m) | (g/cm²) | (10 μΩ · m) |
| Comparative | 0.001 | <0.001 | 0.031 | 127 | 600-650 | 214 | — | — |
| material No. 1 | | | | | | | | |
| Comparative | 0.002 | <0.001 | 0.035 | 134 | 650 | 220 | 7.41 | 2.9 |
| material No. 2 | | | | | | | | |
| Comparative | 0.002 | <0.001 | 0.038 | 121 | 650 | 218 | 7.46 | 4.4 |
| material No. 3 | | | | | | | | |
| Material of | 0.002 | <0.001 | 0.029 | 100 | 550 | 175 | 7.56 | 3.8 |
| the invention No. 4 | | | | | | | | |
| Material of | 0.002 | <0.001 | 0.032 | 98 | 500-550 | 148 | 7.54 | 4.2 |
| the invention No. 5 | | | | | | | | |
| Material of | 0.001 | <0.001 | 0.034 | 113 | 550-600 | 182 | — | — |
| the invention No. 6 | | | | | | | | |
| Material of | 0.002 | <0.001 | 0.033 | 112 | 550-600 | 170 | 7.51 | 3.4 |
| the invention No. 8 | | | | | | | | |
| Material of | 0.002 | <0.001 | 0.037 | 111 | 550 | 155 | — | — |
| the invention No. 9 | | | | | | | | |
| Material of | 0.001 | <0.001 | 0.035 | 115 | 550-600 | 184 | — | — |
| the invention No. 10 | | | | | | | | |
| Material of | 0.002 | <0.001 | 0.033 | 101 | 500-550 | 154 | 7.57 | 4.0 |
| the invention No. 11 | | | | | | | | |
| Material of | 0.001 | <0.001 | 0.028 | 109 | 550 | 150 | 7.55 | — |
| the invention No. 12 | | | | | | | | |
| Material of | 0.002 | <0.001 | 0.034 | 114 | 550-600 | 163 | — | — |
| the invention No. 13 | | | | | | | | |
| Material of | 0.001 | <0.001 | 0.034 | 112 | 550 | 157 | — | — |
| the invention No. 14 | | | | | | | | |
| Material of | 0.002 | <0.001 | 0.032 | 107 | 550 | 143 | 7.56 | 5.1 |
| the invention No. 15 | | | | | | | | |
| Material of | 0.002 | <0.001 | 0.031 | 110 | 550-600 | 171 | — | — |
| the invention No. 16 | | | | | | | | |
| Material of | 0.001 | <0.001 | 0.036 | 109 | 550 | 150 | 7.53 | 4.6 |
| the invention No. 17 | | | | | | | | |
| Material of | 0.002 | <0.001 | 0.034 | 110 | 550 | 155 | — | — |
| the invention No. 18 | | | | | | | | |
| Material of | 0.002 | <0.001 | 0.035 | 114 | 550-600 | 186 | — | — |
| the invention No. 19 | | | | | | | | |
| Material of | 0.002 | <0.001 | 0.030 | 101 | 550 | 153 | 7.56 | 6.3 |
| the invention No. 20 | | | | | | | | |
| Material of | 0.001 | <0.001 | 0.035 | 114 | 550-600 | 150 | 7.58 | 5.2 |
| the invention No. 21 | | | | | | | | |
| Material of | 0.002 | <0.001 | 0.038 | 105 | 550 | 149 | — | — |
| the invention No. 22 | | | | | | | | |
| Material of | 0.002 | <0.001 | 0.037 | 117 | 550-600 | 185 | — | — |
| the invention No. 23 | | | | | | | | |
| Material of | 0.001 | <0.001 | 0.034 | 108 | 550 | 150 | — | 4.5 |
| the invention No. 24 | | | | | | | | |
| Material of | 0.002 | <0.001 | 0.035 | 107 | 500-550 | 156 | 7.54 | 4.7 |
| the invention No. 25 | | | | | | | | |

From the results of chemical analysis shown in Table 2, the oxygen concentrations of powders subjected to hydrogen annealing were all reduced to the range of 0.024 to 0.034% by weight. The amount of C fell within the range of not more than 0.002% for all powders. The amount of N was not more than 0.001%. From this, it was confirmed that the effect of reducing oxygen by the hydrogen annealing is extremely large, and the effects of reducing C and N were also confirmed.

Table 2 shows the results of the Vickers hardness test (load: 10 g) of the powders subjected to hydrogen annealing. The hardness test was carried out by embedding a powder into a resin, polishing it and inserting an indenter on a surface of the cross-section of the powder at room temperature. A relatively large particle was selected and measured at 5 points. The value shown in the table is an average of them. The comparative materials of samples of Nos. 1 to 3 have a hardness exceeding 120 while the materials of the preset invention to which Nb, Ta, Ti, Zr or V are added have a hardness within the range of 98 to 117 and it was confirmed that the hardness is not more than 120. The correlation between the oxygen concentration and the hardness was not clear.

The recrystallization temperatures of the powders subjected to hydrogen annealing were also measured. Each of the powders was directly molded under a pressure of 980 Mpa, without using a lubricant, to obtain a compact of 7 mm×7 mm×2 mm for compression forming. The compact was subjected to an isochronal annealing test in the range from room temperature to 800° C. The annealing was started from 100° C. and raising temperature by ΔT=50° C. and holding time is 30 minutes. The compacts were annealed to 100, 200, 300, 400, 450, 500, 550, 600, 650, 700, and 800, respectively. The annealed compacts were subjected to the hardness test at room temperature in accordance with the aforementioned process.

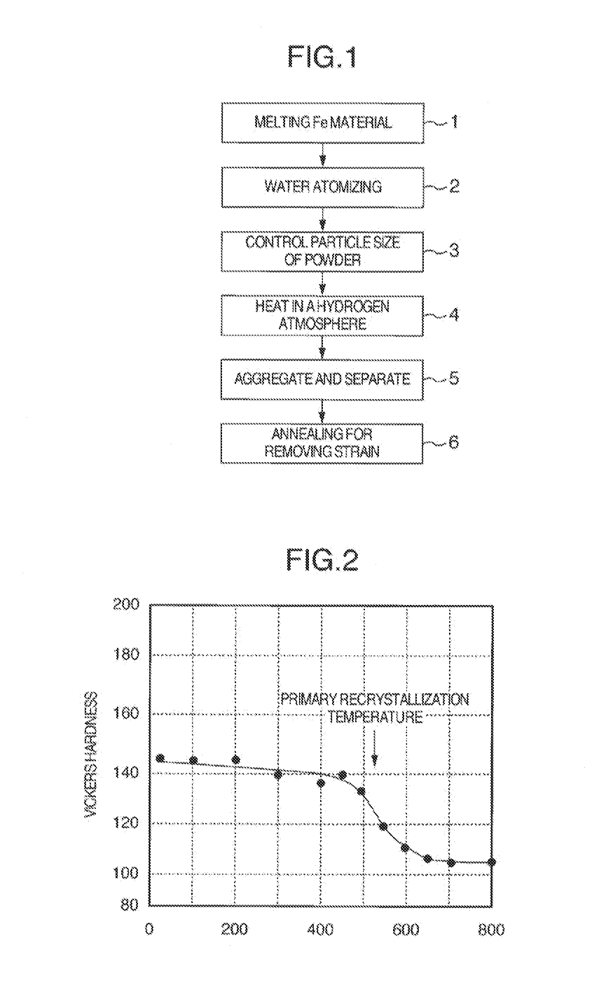

FIG. 2 shows an isochronal annealing curve of the Vickers hardness of the compact of No. 5 powder as an example. The curve significantly goes down from 500° C. and appears to saturate to a hardness of 105 at 600° C. or more. The hardness of 105 is slightly greater than the hardness of 98 of a powder itself subjected to hydrogen annealing. Generally, the hardness of pure iron and low carbon steel decreases almost in proportional to a recrystallization rate. The temperature at which the curve in FIG. 2 shows a extreme value of change (maximum change) was defined as a primary recrystallization temperature. The primary recrystallization temperature of No. 5 was observed between about 500° C. and 550° C. Each material was measured for the primary recrystallization temperature in the same manner.

Table 2 shows the primary recrystallization temperature of each material. The expression “500-550” means 500° C.<primary recrystallization temperature<550° C. The materials Nos. 4 to 25 added with Nb, Ta, Ti, Zr or V have primary recrystallization temperatures of lower than 600° C. It was confirmed that the primary recrystallization temperature is lowered by the addition of the additives. It is presumed that the hardness correlates with the primary recrystallization temperature, since the primary recrystallization temperature tend to be low as the Vicker's hardness lowers.

The compact of material No. 5 was annealed at 530° C. and the interior structure was observed by a transmission electron microscope. The transmission electron microscope used herein is H-9000 UHR (acceleration voltage: 300 kV) manufactured by Hitachi Ltd. The sample for the transmission electron microscope observation was prepared by sampling a piece from a compact by applying a Ga ion beam and thinning the piece in accordance with the focused ion beam (FIB) micro sampling method.

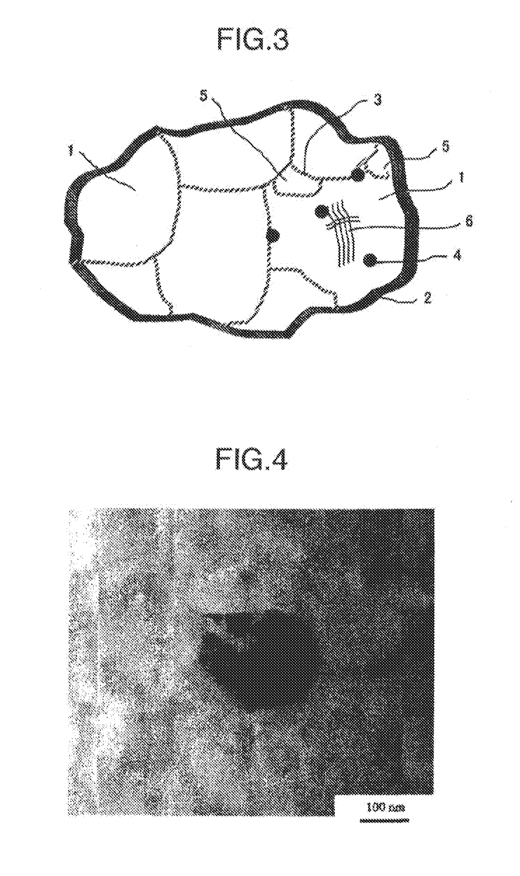

FIG. 3 is a schematic view showing the observed structure of a pressed powder in the compact. The pressed powder particles had an average particles size of about 120 μm and were polycrystalline substances each composed of an assembly of single crystals 1 having a particle size of 10 to 30 μm. The surface of the pressed powder was coated with an oxide-containing thin film 2 having a thickness of 0.1 to 0.5 μm. Microcrystals 5 having a grain size of not larger than 10 μm were partly observed, particularly near the surface. In the matrix of a single crystal 1, precipitations 4 and a dislocation 6 introduced by processing were partly observed. The presence of the remaining dislocation 6 may indicate that the primary crystallization is not fully completed.

In the matrix and grain boundary 3, precipitations 4 were observed. FIG. 4 shows an electron micrograph of one precipitation in the matrix taken by a transmission electron microscope. The precipitation was formed of oxides containing an impurity metal element and an additional element and having a particle size of 50 to 200 nm (0.05 to 0.2 μm, an average size: 0.1 μm). It distributed at a ratio of 4 to 5 particles/200 μm². A large precipitation on the order of micrometer was not found. The precipitation was a mixed oxide and confirmed to contain Fe, Cr, Mn, Nb and O according to the EDX spectroscopy (energy dispersive X-ray spectroscopy). In the observed mixed oxide, the content of oxygen fell within the range of 50% to 70%. At the detection level of the measurement herein, an oxide solely formed of Fe was not detected and metal carbides, metal nitrides and sulfides were not observed.

Material Nos. 9, 12, 14, 18, 21 and 25 were observed in the same manner. Mixed oxides containing Nb, Ta, Ti, Zr or V, which were previously added to each powder, were observed as precipitations as the same as in material No. 5.

Although some precipitations having a size of several nm failed to be observed in the limited field of view under the resolution of the transmission electron microscope, the compacts of water atomized powder subjected to hydrogen annealing contained mixed oxides, most of which were not finely dispersed but sufficiently grown.

As shown in the results of Table 2, comparative materials of Nos. 1 to 3 tend to have a higher primary recrystallization temperature (not lower than 600° C.) than the materials of the present invention. The powders of comparative materials of Nos. 1 to 3 were observed by a transmission electron microscope in the same manner, and many extremely fine precipitations having a grain size of several nm to 20 nm were present by not less than 100 particles per 200 μm². Accordingly, it was confirmed that, unlike the materials of the present invention, fine precipitations are densely dispersed in the comparative materials. From the EDX spectroscopy, it was found that fine precipitations are constituted of Fe, Cr, Mn and O, and that a mixed oxide is principally composed of Fe—Cr—Mn. Therefore, in comparative materials which do not contain Nb, Ta, Ti, Zr or V, it is presumed that a large number of small mixed oxides are precipitated and the deformation resistance of the Fe powder increased so that the primary recrystallization temperature did not decrease.

### Example 2

Next, the magnetic properties of a powder magnetic core of the water atomized powder according to the present invention were checked. The powder subjected to hydrogen annealing having a particle size of 30 μm to 200 μm, mainly around 100 μm, was soaked in an aqueous phosphate solution. In this way, the surface of the particles was coated with an iron-phosphate glass insulating film. Subsequently, the Fe powder coated with the insulating film, to which a lubricant was added, was subjected to pressure molding at a pressure of 980 MPa to obtain a magnetic compact. The compact had a ring shape having an outer diameter of 25 mm, an inner diameter of 15 mm and a thickness of 5 mm. Since the heatproof temperature of the iron-phosphate glass is at most 550° C., the annealing of the compact was performed at 530° C. for 60 minutes in a nitrogen gas atmosphere.

The magnetic properties were evaluated based on coercive force. The measurement results of coercive force of individual compacts of the powders coated with the insulating film are shown in Table 2. The comparative materials Nos. 1, 2 and 3 do not contain Nb, Ta, Ti, Zr or V and have a coercive force exceeding 200 A/m. It is estimated that they have a hysteresis loss of not less than 33 w/kg. On the other hand, materials Nos. 4 to 25 containing Nb, Ta, Ti, Zr or V have a coercive force within the range of 150 to 200 A/m. The coercive force changed almost in the same manner as hardness and the primary recrystallization temperature.

The density and specific resistance of a compact annealed as above were measured for some samples. The density was measured by the Archimedes method and the specific resistance was measured by a four-terminal method. The measurement results are shown in Table 2. The materials containing Nb, Ta, Ti, Zr or V satisfied a density of not lower than 7.45 and a specific resistance of not lower than 20 μΩ·m.

From the above results, it was demonstrated that a technique for improving magnetic properties, such as the strength of a magnetic compact, reduction of primary recrystallization temperature, and coercive force (i.e., iron loss), can be obtained by adding at least one element selected from the group consisting of Nb, Ta, Ti, Zr and V to an Fe powder within an appropriate range, and by annealing in a hydrogen-containing reduction atmosphere, as the present inventors state.

### Example 3

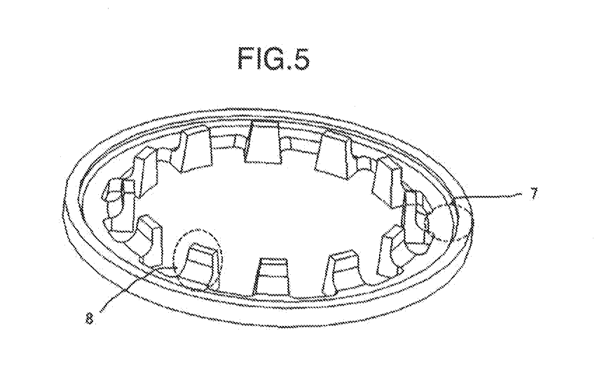

In the same manner as Example 2, developed materials Nos. 5, 12, 15 and 21 were coated with an insulating film and treated with a lubricant, and subjected to molding to form a three-dimensional powder magnetic core as a magnetic core of motor. FIG. 5 shows a schematic view of the powder magnetic core having an outer diameter of 90 mm and a height of 10 mm. The forming pressure was 980 MPa. Several samples were taken from a flange portion 7 and a nail portion 8 of the developed material and their densities were measured by the Archimedes method. The densities of the nail portions of materials Nos. 5, 12, 15 and 21 were 7.55, 7.54, 7.56 and 7.56, respectively. The densities of the flange portions including an outer periphery and a flat portion were lower by 0.01 to 0.03 than those of the nail portions.

While there is difference from two-dimensional shape of Example 2, the three-dimensional compact formed by molding herein was confirmed to have a high density. Accordingly, it is believed that the same thermal and magnetic properties as in Example 2 can be obtained in the three-dimensional compact.

It is obvious to one skilled in the art that the present invention is not limited to Examples as mentioned above and various modifications and changes may be made without departing from the sprit of the present invention and the scope of the claims attached hereto.

The Fe powder, soft magnetic material, powder magnetic core and methods of manufacturing the same according to the present invention can be used generally in motor cores, electromagnetic valves, reactors or electromagnetic components.

### DESCRIPTION OF REFERENCE NUMERALS

1 single crystal of α-iron
2 thin oxide film layer
3 grain boundary
4 precipitation
5 microcrystal
6 dislocation
7 flange portion
8 nail portion

1. A method for manufacturing a magnetic compact comprising:
cooling a molten alloy by spraying water, the molten alloy containing iron as a main component and at least one element selected from the group consisting of V, Nb, Ta, Ti and Zr in an amount of 0.001 to 0.03 atom %;
annealing the atomized alloy powder at a temperature from 800° C. to 1000° C. in a hydrogen-containing reduction atmosphere; and
compacting the alloy powder,
wherein the method further comprising a step of recrystallizing the magnetic compact, after the compacting, at a recrystallization temperature of not higher than 600° C.

2. The method according to claim 1, further comprising a step of coating the annealed alloy powder with an insulating layer and compacting the alloy powder of powder particles having the insulating layer.

3. A method for manufacturing a soft magnetic powder comprising:
cooling a molten alloy by spraying water, the molten alloy containing iron as a main component and at least one element selected from the group consisting of V, Nb, Ta, Ti and Zr in an amount of 0.001 to 0.03 atom %; and
annealing the atomized alloy powder at a temperature form 800° C. to 1000° C. in a hydrogen-containing reduction atmosphere.

4. The method according to claim 3, further comprising a step of coating the annealed alloy powder with an insulating layer, after the annealing.
